(19) United States
(12) Patent Application Publication
(10) Pub. No.: US 2004/0052366 A1
(43) Pub. Date: Mar. 18, 2004

(54) Method and array for transmitting secured information

(76) Inventor: Siegfried Huber, Reichertshofen (DE)

Correspondence Address: MORRISON & FOERSTER LLP, 1650 TYSONS BOULEVARD, SUITE 300, MCLEAN, VA, 22102, US

(21) Appl. No.: 10/221,504

(22) PCT Filed: Jun. 25, 2001
(86) PCT No.: PCT/DE01/02325

(30) Foreign Application Priority Data
Jun. 27, 2000 (DE) 100 31 176.8

(51) Int. Cl. H04K 1/00; H04L 9/00

(52) U.S. Cl. 380/28

(57) ABSTRACT

Information (I) is divided into information fragments (FR₁, FR₂), on the basis of which a third information fragment (FR₃) is formed by means bitwise EXOR. The three information fragments (FR₁-FR₃) are then transmitted over separate channels (k). Additional information (ZI) for reconstructing the original information (I) sequence is also formed and transmitted. The channels (K) can thus be realized in asynchronous coupling fields.

Switching networks in switching systems that operate, for example, in the Asynchronous Transfer Mode (ATM), often require redundancy in order to attain a high system reliability, despite defects in assemblies, etc. If functions or functional groups fail, it should be particularly assured that none of the information transmitted by these groups becomes lost.

The high system reliability is attained, for example, by doubling the information and transmitting it over two identical switching networks. One of the two sets of information—preferably the set that was transmitted error-free—is subsequently transmitted further. An error check is to be performed at the outputs of the two redundant switching networks in the information transmission. If the redundant sets of information have both been transmitted error-free, only one set is to be transmitted further.

In this method, it is necessary to use at least two switching networks. The method is therefore also referred to hereinafter as a “two-path method.” The number of required switching networks increases accordingly with a high volume of information. For switching networks having a horn structure, this increase is quadratic, which is uneconomical. The connecting functionality of the switching networks also becomes increasingly complex. This is particularly the case for switching networks having a horn structure, which places stringent requirements on the cable layout.

An alternative method is described in U.S. patent application Ser. No. 09/336,090, which was not published prior to the present application. In this method, the information is divided and transmitted on two identical switching networks. Generally, the divided information is recombined at the output of the switching networks. The high system reliability is achieved through the formation of additional information from the divided information by means of bit-wise EXOR, and the transmission of this information on a third coupling multiple. If one half of the divided information is transmitted with errors, it is reconstructed through a repeated, bit-wise EXOR between the two sets of information that were transmitted error-free.

This method requires the use of at least three switching networks. The method is therefore also referred to hereinafter as a “three-path method.” The advantages of this method are evident in the example of information transmission through ATM cells, in which instance the divided information is transmitted in, for example, half-cells. In contrast to transmitting with full cells, in which case the internal cells contain, for example, 64 bytes (53 bytes for the ATM cell, 11 bytes for an internal overhead) for transmitting the information within the switching system, a half-cell contains only, for example, 38 bytes (27 bytes for the divided ATM cell, 11 bytes for the internal overhead). This increases the throughput in comparison to switching networks that process ATM full cells if the data throughputs in the construction and connecting technology are identical. A comparison is offered for clarification: Instead of achieving a total throughput of the redundant structure of 160 Gbit/s with two 160 Gbit/s full-cell switching networks, three half-cell switching networks (each having 160 Gbit/s) can achieve a data throughput of 270 Gbit/s with full redundancy. The half-cell switching networks can therefore transmit approximately 1.7 times more information with the same data rate in the structural technology. An advantage is that the necessary, higher processing speed is easier to attain in the half-cell switching networks than in the connecting technology and the I/O structures of the modules of the switching system.

In both methods, when information is transmitted by means of ATM cells, the sequence of the information must be maintained.

In the two-path method, this is achieved, for example, through the further transmission of only the information from one of the two coupling-multiple discs if faulty operation has occurred. Thus, the original sequence of the information is retained, because typically no permutation of information occurs within the switching networks.

This procedure is not employed in the three-path method, because the divided information is transmitted by two switching networks, and must be recombined at the output of the two switching networks. It must be observed here that vastly different transit times can occur, despite the identical construction of the two switching networks. If the divided information were recombined without additional measures, it would be highly probable that the information would be permutated. U.S. Ser. No. 09/336,090 therefore proposes to synchronize the three switching networks among themselves so as to avoid differences in transit times. This is, however, a complicated task in large switching systems because of, for example, increasingly diverging line lengths in the connecting technology as the size of the system increases.

It is an object of the invention to improve the method not published prior to the present application with respect to a secured information transmission. The object is accomplished by the features of claim 1.

An essential aspect of the invention lies in a method for the secured transmission of information, comprising the following steps:

The information is divided into a first and a second information fragment;

A third information fragment is formed from the two information fragments through a bit-wise EXOR;

Each information fragment is transmitted in a separate channel; and

Additional information is produced and transmitted for reproducing the original sequence of the information.

An essential advantage of the invention is that the information fragments can be transmitted in the separate channels without being synchronized with each other, because the additional information is used to ascertain transit-time differences. Therefore, a wide range of switching systems can be realized, because the cabling between switching networks and I/O assemblies, which is usually extremely complex, can be arbitrary, i.e., embodied without consideration of resulting transit-time differences. The channels can therefore be realized without synchronization, that is, asynchronously. If the channels are realized in redundant switching networks, they need not be synchronized. In addition, particularly in the use of horn switching networks, the division of the information onto two channels permits larger data throughputs while maintaining the optimum horn structure.

According to a modification of the method of the invention, in the use of sequence numbers, their value range is selected such that the transit-time differences that are usually anticipated to occur in the channels can be reliably compensated (claim 3). This advantageously minimizes the capacity required for transmitting the additional information.

In accordance with an embodiment of the method of the invention, it is provided that, in the structuring of the information in small units of identical format, and the uniform division of the information onto the first and second information fragments, the bit-wise EXOR is applied to two corresponding, small units occupying the same position within the two information fragments. The small unit formed here occupies the same position within the third information fragment as the corresponding small units within the first and second information fragments (claim 4). In this way, the transmission of position information is eliminated, which optimizes the capacity available for transmitting the information.

According to a modification of the method of the invention, the transmitted information fragments are written into a memory at the output of the channels (claim 5). In accordance with a variation of the method of the invention, when a Traffic Management is used in the channels, the same memory is used for this as for storing the transmitted information fragments (claim 6). The multiple use of the memory economically optimizes the realization of an arrangement in which the method of the invention is executed.

According to an embodiment of the method of the invention, it is provided that, in the transmission of the fragment-specific information units in switching networks of a switching system in which internal, system-specific headers precede the fragment-specific information units, the additional information is respectively transmitted in the internal headers (claim 8). The use of internal headers, which usually occur in such switching systems, omits special methods for transmitting the additional information.

According to a variation of the method of the invention, at least the internal headers are secured by a checksum (claim 9). This advantageously prevents the divided information from being combined in incorrect order due to erroneously transmitted additional information.

Further advantageous embodiments of the invention ensue from the independent and dependent claims.

The method of the invention is described in detail below in conjunction with two figures. Shown are in:

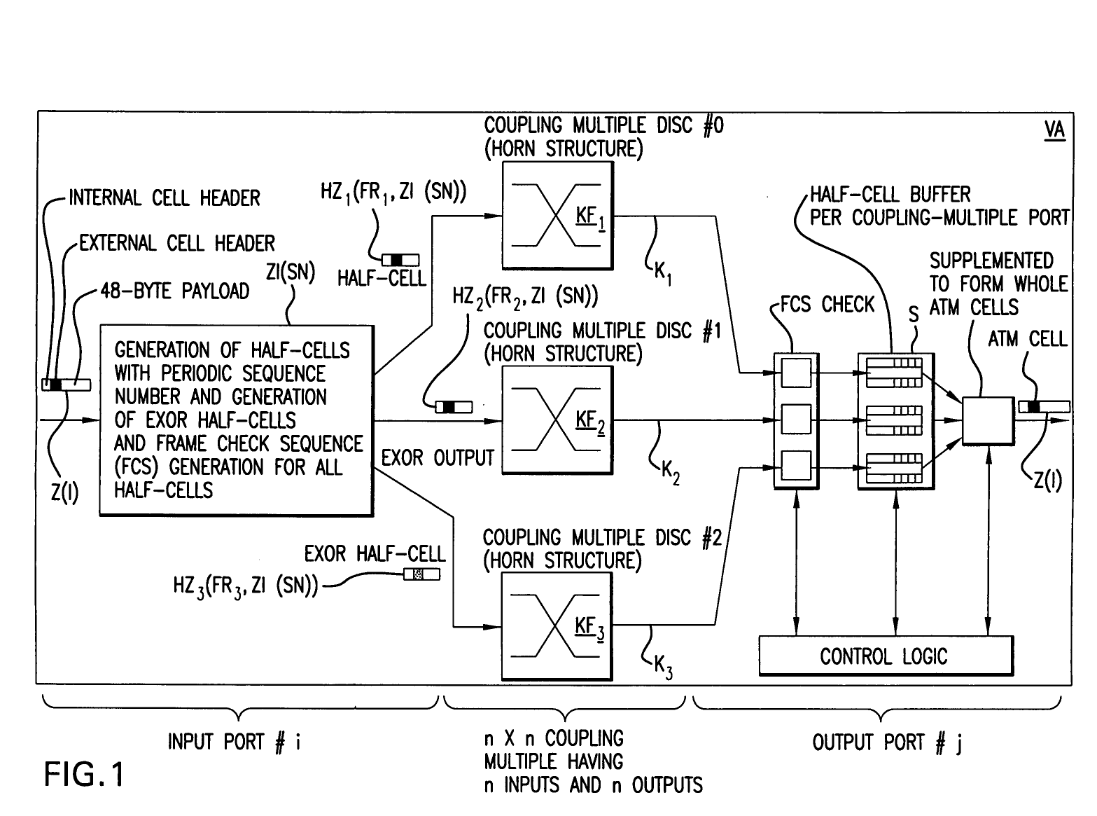

FIG. 1 a block diagram of functional groups of a switching system according to the invention, having three switching networks for performing an information transmission in accordance with the invention;

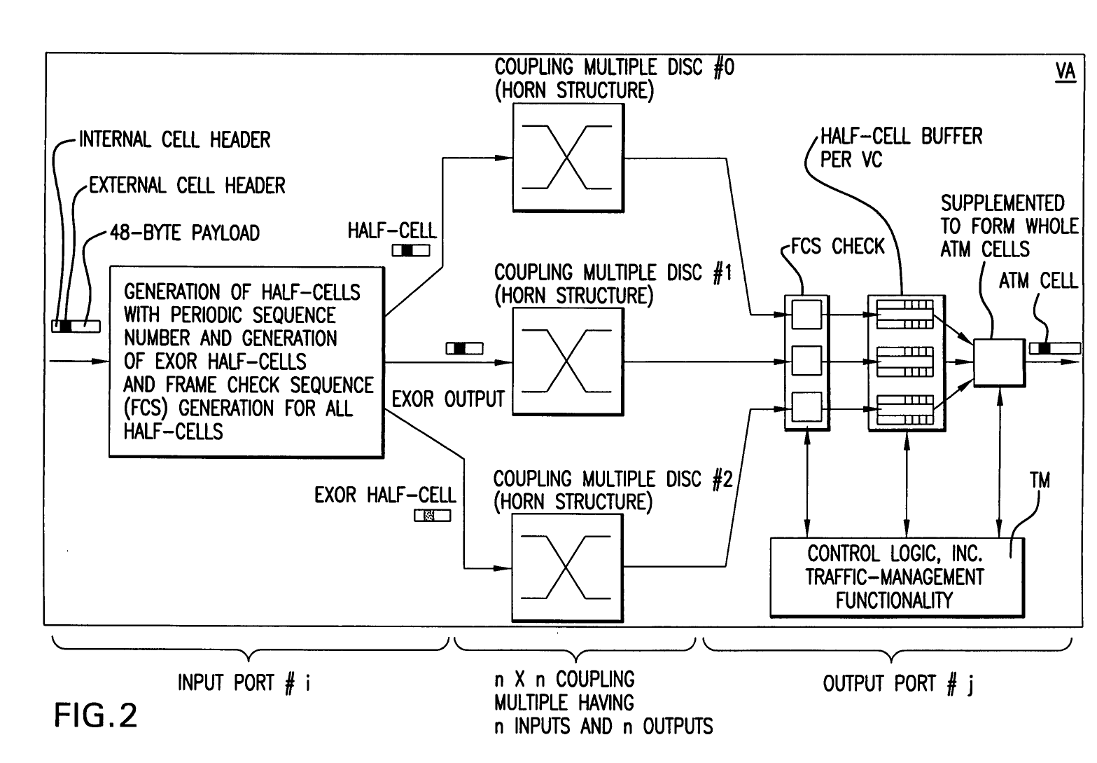

FIG. 2 a block diagram of functional groups, combined with traffic-management functions, of a switching system according to the invention; and

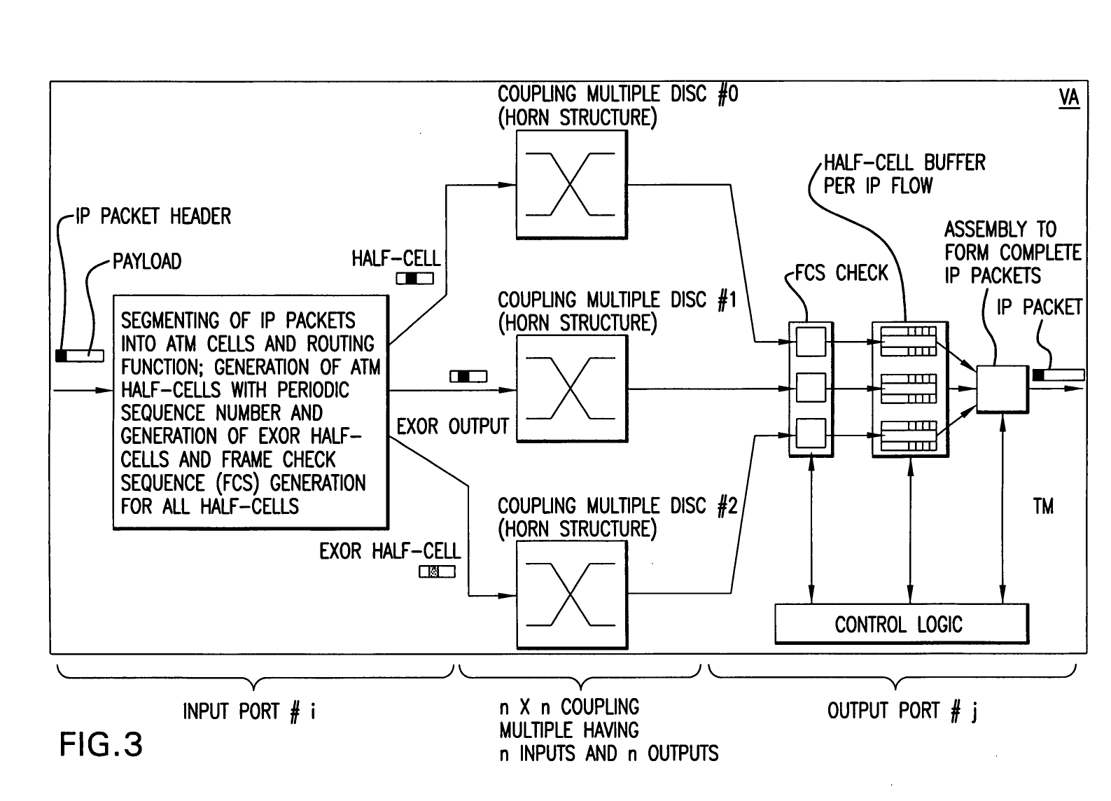

FIG. 3 a block diagram of functional groups of a switching system according to the invention for IP router applications.

The figures illustrate exemplary arrangements for performing an information transmission according to the invention. The arrangements are embodied as switching systems having switching networks, in which the information is transmitted in, for example, (ATM) cells Z. A person of skill in the art will recognize, however, that other, arbitrary transport formats, such as packets or frame structures, may also be used.

FIG. 1 shows a switching system VA having three switching networks KF. A channel K is respectively realized from each coupling multiple KF. A functional group for generating fragment-specific information units HZ embodied, for example, as half-cells, with additional information ZI in the form of sequence numbers SN, for generating third information fragments FR₃, and for forming checksums FCS for all half-cells HZ, is connected in series with the switching networks KF. A function for checking the checksums FCS, a memory S for half-cells HZ that were transmitted error-free, with memory queues per coupling-multiple port, and a function for constructing whole (ATM) cells Z are connected in series at the output of the switching networks KF. The interaction of these three functional blocks is controlled by a control logic connected in parallel. The (ATM) cells Z supplied to the arrangement have, in addition to the standardized 48-byte payload and the 5-byte header—also called cell header a system-specific internal cell header having, for example, 11 bytes. An internal cell Z therefore contains 64 bytes.

FIG. 2 illustrates a switching system VA, which is essentially identical in design to the one shown in FIG. 1. In contrast to the embodiment shown in FIG. 1, the functional groups are combined with traffic-management functions. To this end, the control logic is expanded by a traffic-management functionality TM. In addition, the half-cells HZ are stored in the memory S because of the traffic-management functionality TM, not per coupling port, but per virtual (ATM) connection.

The switching system VA illustrated by way of example in FIG. 3 is essentially identical to the one shown in FIG. 1. In contrast to the system in FIG. 1, packets that are embodied in accordance with the Internet format IP are transmitted from the external I/O assemblies of the switching system VA. Internally, however, the IP packets are transmitted with the aid of cells Z and half-cells HZ. In contrast to the switching system VA shown in FIG. 1, the IP packets are segmented into (ATM) cells Z in functional groups connected in series with the switching networks KF. A further difference is that the original IP packets, not whole (ATM) cells Z, are constructed at the output of the switching networks KF.

For the exemplary embodiment, it is assumed that the information I is usually transmitted in small information units Z, also called frames, packets, data packets or cells. These information units Z contain, for example, the information I of the original information stream (also referred to as useful information, data or useful data), as well as additional information (also called overhead) for controlling the process of transmitting the information units Z.

An exemplary embodiment for executing the method of the invention is embodied as a switching system VA having three switching networks KF. The information I is transmitted at least within the switching system VA on the basis of uniformly structured information units Z, which are embodied as, for example, (ATM) cells Z or half-cells HZ.

It is pointed out here that these concrete examples serve merely in facilitating the understanding of the invention, and are not intended to be limiting. It may be apparent to a person of skill in the art that the invention can also be embodied in more extensive arrangements, and with the aid of other information units Z.

When the cells Z enter the switching system VA, the information I transmitted in them is divided into two information fragments FR₁, FR₂. In the structuring of the information I into small units of identical format—for example, bytes containing eight bits—the information is divided evenly onto, for example, fragment-specific information units HZ embodied as two half-cells HZ₁, HZ₂. For example, the first half-cell HZ₁ is formed from the bytes having an odd position, and the second half-cell HZ₂ is formed from the bytes having an even position. In the case of an odd number of bytes, the second half-cell HZ is filled with, for example, a byte having the value 0. The fixed position data allow a receiver of the transmitted half-cells HZ to regenerate the information I in its original sequence.

Furthermore, a third information fragment FR₃ is formed through bit-wise EXOR from the information I divided in this manner. For example, the bit-wise EXOR is applied to two corresponding bytes having the same position within the two formed half-cells HZ₁, HZ₂. The byte formed here has the same position within the third half-cell HZ₃ as the corresponding bytes within the two other half-cells HZ₁, HZ₂.

Moreover, additional information ZI is formed for reproducing the original sequence of the information I. This information is embodied as, for example, sequence numbers SN and/or time data. The information characterizes the half-cells HZ. The three half-cells HZ₁-HZ₃, which stem from the original (ATM) cell Z, are characterized with the same additional information ZI.

The half-cells HZ (FR, ZI (SN)) formed in this manner are subsequently transmitted in separate channels K, which are realized in, for example, the switching networks KF of the switching system VA. The additional information ZI is transmitted in the cell headers of the half-cells HZ. In the use of sequence numbers SN, their value range is selected such that the transit-time differences that are typically anticipated to occur in the channels K are reliably compensated. The internal headers of the half-cells HZ can optionally be secured by a checksum FCS.

After the half-cells HZ have been transmitted, the checksum FCS provided in accordance with an embodiment of the invention is checked at the outputs of the switching networks KF for each of the three half-cells HZ. If the sum is error-free, the half-cell HZ is written into the memory S; otherwise, the half-cell is rejected in order to avoid erroneous functions due to, for example, an incorrect sequence number SN or an incorrect output port number resulting from a faulty routing address. The storage locations in the memory S are cyclically overwritten per port number, according to the sequence number SN.

The storage—also called queuing—is preferably effected per the coupling-multiple port in order to save storage space or avoid a delay. The number of the input port, for example, is contained in the internal cell header to control the storage process. As a variation, however, it is also possible to effect connection-individual queuing—that is, per Virtual Connection (VC). Here, the VC number is derived, for example, from the internal cell headers of the half-cells HZ. The maximum queue length preferably matches the maximum sequence number.

The half-cells HZ having the same sequence number SN are then combined per port of origin to form complete (ATM) cells Z. The following cases may occur:

(1) Half-cells HZ from switching networks KF₁ and KF₂ are present:

=>Whole (ATM) cell Z is generated (normal case).

(2) Half-cell HZ from coupling multiple KF₁ is missing, but half-cells HZ from switching networks KF₂ and KF₃ are present:

=>The whole (ATM) cell Z is regenerated through the reversal of the EXOR function onto the half-cell HZ from coupling multiple KF₃ (with the aid of the half-cell from KF₂).

(3) The half-cell HZ from coupling multiple KF₂ is missing, but half-cells HZ from switching networks KF₁ and KF₂ are present:

=>The whole (ATM) cell Z is regenerated through the reversal of the EXOR function onto the half-cell from coupling multiple KF₃ (with the aid of the half-cell HZ from KF₁).

(4) The half-cell HZ from the coupling multiple KF₃ is missing, but half-cells HZ from switching networks KF₁ and KF₂ are present:

=>The whole (ATM) cell Z is generated in (1).

(5) Half-cells HZ from two or all three switching networks KF are missing:

=>The whole (ATM) cell Z cannot be generated (=cell loss).

For recognizing a defect in a coupling multiple KF, an alarm can be effected when half-cell losses occur in one of the switching networks KF. The number of successive necessary half-cell losses is established by a threshold value (threshold) for avoiding false alarms, for example due to sporadic bit errors.

Maintaining the bit synchronization in the transmission layer in asynchronous operation of the arrangement is effected, for example, by empty cells, which are characterized as such in the internal cell header. Empty cells Z or half-cells HZ are immediately rejected at the inputs of modules. They are inserted at the module outputs if an unfilled cell Z or half-cell HZ is awaiting transmission. Thus, the bit synchronization on the lines is maintained, while the internal module functions are protected from a non-utilized load.

The three switching networks KF for transmitting half-cells can incorporate methods for traffic management TM, such as Dynamic Bandwidth Allocation or Back Pressure. An advantage of this arrangement is that the buffer functionality for the half-cells HZ is combined with the buffer function of the traffic management, which is memory-intensive anyway, for saving memory space. In this instance, the intermediate storage is effected within the three channels K due to the ATM traffic management TM per Virtual Connection.

In the embodiment of the arrangement as a switching system VA having an IP router functionality, incoming IP packets are segmented in a first step, for example, into (ATM) cells (e.g., AAL 5) Z, then transmitted according to the method of the invention. At the output of the switching networks KF, the storage of the half-cells HZ is combined with the storage of the cells Z, which is required anyway, until the IP packets have been completely transmitted, in order to save storage space. The IP packets are assembled directly from the half-cells. This assembly is preferably effected through the direct retrieval of the necessary information I from the memory S. An intermediate construction of the original (ATM) cells Z is therefore not necessary. The storage is effected, based on the IP functionality, in each of the three half-cell memories according to the IP flow. The routing functionality is effected in accordance with the prior art.

1. A method for the secured transmission of information (I), comprising the following steps:
The information (I) is divided into a first and a second information fragment (FR₁, FR₂);
A third information fragment (FR₃) is formed from the two information fragments (FR₁, FR₂) through a bitwise EXOR;
Each information fragment (FR) is transmitted in a separate channel (K); and
Additional information (ZI) is produced and transmitted for reproducing the original sequence of the information (I).

2. The method according to claim 1, characterized in that the additional information (ZI) is in the form of sequence numbers (SN) and/or time data.

3. The method according to claim 2, characterized in that, in the use of sequence numbers (SN), their value range is selected such that the transit-time differences that are usually anticipated to occur in the channels (K) can be reliably compensated.

4. The method according to one of claims 1 through 3, characterized in that, in the structuring of the information (I) in small units of identical format, and the uniform division of the information onto the first and second information fragments (FR₁, FR₂), the bit-wise EXOR is applied to two corresponding, small units occupying the same position within the two information fragments (FR₁, FR₂), with the small unit formed here occupying the same position within the third information fragment (FR₃) as the corresponding small units within the first and second information fragments (FR₁, FR₂).

5. The method according to one of the foregoing claims, characterized in that the transmitted information fragments (FR) are written into a memory (S) at the output of the channels (K).

6. The method according to claim 5, characterized in that, in the use of a traffic management (TM) in the channels (K), the same memory (S) is used as for storing the transmitted information fragments (FR).

7. The method according to one of the foregoing claims, characterized in that, in the transmission of the information (I) in information units (Z), information units (Z) divided into information fragments (FR) are transmitted in fragment-specific information units (HZ), which are characterized with the same additional information (ZI).

8. The method according to claim 7, characterized in that, in the transmission of the fragment-specific information units (HZ) in switching networks (KF) of a switching system (VA) in which internal, system-specific headers precede the fragment-specific information units (HZ), the additional information (ZI) is respectively transmitted in the internal headers.

9. The method according to claim 8, characterized in that at least the internal headers are secured by a checksum (FCS).

10. An arrangement for executing a method according to one of the foregoing claims.
